(19) United States
(12) Patent Application Publication
(10) Pub. No.: US 2005/0273541 A1
(43) Pub. Date: Dec. 8, 2005

(54) Circuit and method for adaptively recognizing a data packet in a universal serial bus network device

(75) Inventors: Michael L. Hayenga, Dallas, TX (US); Sabyasachi Dey, Karnataka (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/861,689

(22) Filed: Jun. 4, 2004

(51) Int. Cl. G06F 13/14

(52) U.S. Cl. 710/305

(57) ABSTRACT

A circuit for, and method of, adaptively recognizing a data packet (such as an Internet Protocol, or IP, packet) and a USB device containing a system-on-a-chip incorporating the system or the method. In one embodiment, the circuit includes: (1) a USB endpoint configured to receive USB packets bearing portions of the data packet and (2) a short packet detector associated with the USB endpoint and configured to detect and respond to a received short USB packet by causing at least some of the USB packets to issue from the USB endpoint.

### TECHNICAL FIELD OF THE INVENTION

The present invention is directed, in general, to Universal Serial Bus (USB) network devices and, more specifically, to a circuit and method for adaptively recognizing a data packet in a USB network device.

### BACKGROUND OF THE INVENTION

The Universal Serial Bus (USB) has become an extraordinarily popular way for computer users to couple peripheral devices to their computers. USB replaces a disparate variety of different typically large and temperamental interfaces (such as serial, parallel and SCSI) with a single, hot-pluggable, plug-and-play, thin, nonetheless fast, interface. Designers of the USB standard were intent on making peripheral attachment as simple for users as plugging in a telephone.

A USB cable (which is essentially a pair of conductors) provides a USB link between two “endpoints.” One endpoint manages the link and is called the “controller” or “host.” The other endpoint takes direction from the host and is called the “device.” Buffer memories are provided at both endpoints to hold data for the serialization and deserialization that occurs during transmission over the USB link. Standardized control messages communicated between the host and the device allow a USB link to be recognized, labeled (“enumerated”), maintained (“kept alive”) and terminated (“halted”). Four types of USB packets are currently defined: “Bulk” (for transferring bulk data), “Control” (for control messages), “Interrupt” (for asserting interrupts) and “Isochronous” (for establishing isochronous connections). According to the current USB standard, each packet type has a maximum length. For example, the maximum length for a Bulk packet is 512 bytes; the maximum length for an Isochronous packet is 1024 bytes. The endpoints negotiate specific packet lengths during enumeration.

Two competing protocols exist for managing communication over a USB link. The de facto standard (but limited to Microsoft operating systems) is Microsoft's Remote Network Driver Interface Specification (RNDIS) (see, e.g., http://msdn.microsoft.com/library/en-us/network/hh/network/rndisover_{—}6kiv.asp, incorporated herein by reference). The official, but less-employed standard is the USB Implementers Forum's Communications Device Class (CDC) (see, e.g., http://www.usb.org/developers/devclass_docs/usbcdc11. pdf, incorporated herein by reference). These protocols specify the control messages referred to above and specific lengths for the USB packets.

Although capable of performing in many roles, USB was early in its development perceived as a means by which network devices could be coupled to computers. The USB standard was therefore designed such that a USB link could bear the types of data packets that traverse networks. The Internet Protocol (IP) underlies the Internet and is therefore currently a predominant network layer protocol. Thus, many applications call for transferring IP packets (one type of network layer protocol packet) over USB links.

IP packets can range in length anywhere from 64 bytes to 1514 bytes. Because even the largest USB packets are less than 1514 bytes long, it is common for an IP packet to span multiple USB packets. During a bulk data transfer, each USB packet is buffered at the receiving endpoint. Each packet received message typically prompts a hardware interrupt to be generated which, in turn, prompts a driver associated with the receiving endpoint to move the USB packet out of the buffer into memory associated with the driver. When the last USB packet corresponding to the particular IP packet is received, the driver moves the last USB packet into its memory, reassembles the IP packet and forwards it to a protocol stack for further processing.

It is therefore apparent that the transfer of even a single IP packet across a USB link involves both a buffer and additional memory at the receive endpoint and often involves multiple interrupts and multiple data moves. The additional memory complicates the design of the receiving endpoint, and the interrupts and data moves consume processing time and other resources. The resulting inefficiency limits the data transfer rate of the USB link. What is needed in the art is a way to increase the data transfer rate of a USB link as it pertains to transfer of IP packets.

### SUMMARY OF THE INVENTION

To address the above-discussed deficiencies of the prior art, the present invention provides a circuit for, and method of, adaptively recognizing a data packet and a USB device containing a system-on-a-chip incorporating the circuit or the method. The present invention takes advantage of the fact that the transfer of a data packet over a USB link necessarily ends in a short (or empty) USB packet. The present invention recognizes that significant processing time and resources can be saved, and USB bandwidth increased, by foregoing separate transfers of individual USB packets out of the buffer and instead using receipt of the terminating short packet as a cue to transfer the data packet whole or in at least larger part.

In one embodiment, the circuit includes: (1) a USB endpoint configured to receive USB packets bearing portions of the data packet and (2) a short packet detector associated with the USB endpoint and configured to detect and respond to a received short USB packet by causing at least some of the USB packets to issue from the USB endpoint.

In another aspect, the present invention provides a method of adaptively recognizing a data packet. In one embodiment, the method includes: (1) receiving USB packets bearing portions of the data packet and (2) responding to a received short USB packet by causing at least some of the USB packets to issue from a USB endpoint.

In yet another aspect, the present invention provides a USB device. In one embodiment, the device includes: (1) a system-on-a-chip having: (1a) a processor configured to enable a protocol stack, (1b) a buffer, (1c) a USB endpoint configured to receive USB packets bearing portions of the data packet and (1d) a short packet detector associated with the USB endpoint and configured to detect and respond to a received short USB packet by causing at least some of the USB packets to issue from the USB endpoint to the protocol stack and (2) a USB connector coupled to the USB endpoint.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of a USB link including one embodiment of a circuit for adaptively recognizing a data packet constructed according to the principles of the present invention;

FIG. 2 illustrates a flow diagram of one embodiment of a method of adaptively recognizing a data packet constructed according to the principles of the present invention; and

FIG. 3 illustrates a block diagram of one embodiment of a USB device containing a system-on-a-chip incorporating the circuit of FIG. 1 or the method of FIG. 2.

### DETAILED DESCRIPTION

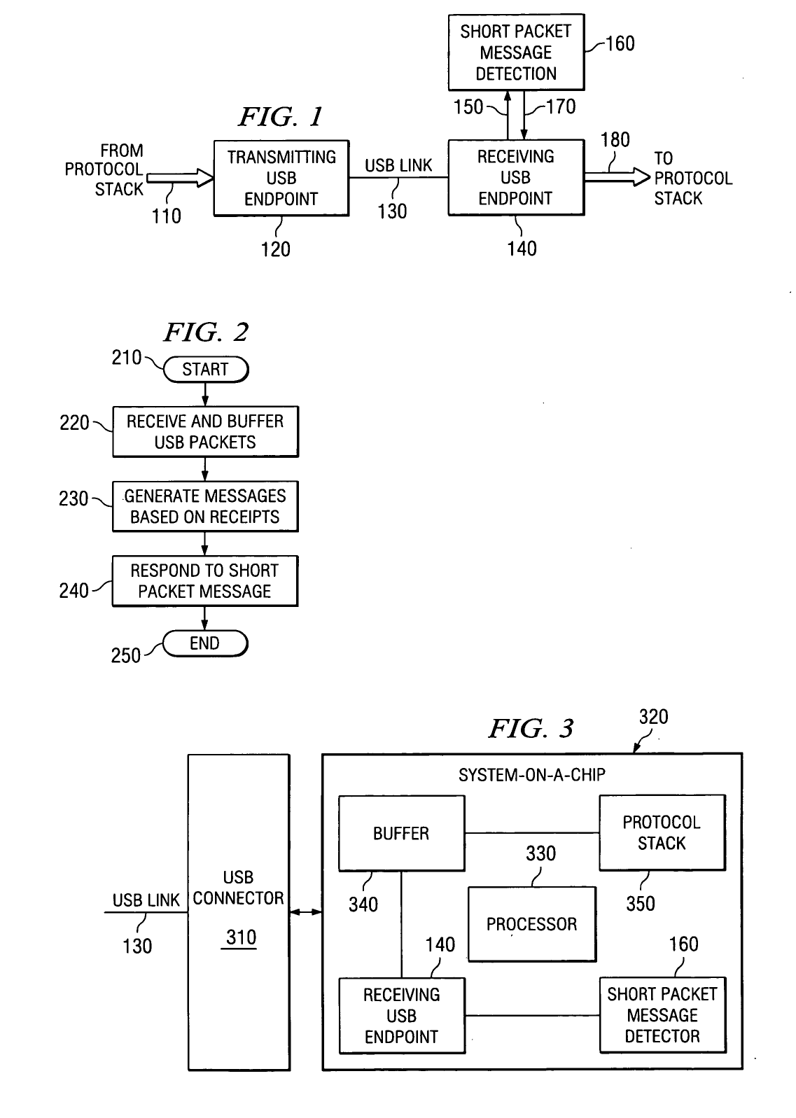

Referring initially to FIG. 1, illustrated is a block diagram of a USB link including one embodiment of a circuit for adaptively recognizing a data packet (such as an IP packet) constructed according to the principles of the present invention. Those skilled in the pertinent art understand that USB links are bidirectional. The present invention is preferably embodied on the receiving endpoint of a USB link. Accordingly, only one-way communication across a USB link will be illustrated.

A data packet to be transmitted across a USB link travels on a path 110 from a protocol stack (not shown) to a transmitting USB endpoint 120. As those skilled in the pertinent art understand, the data packet is first divided into portions of lengths that depend upon a prenegotiated USB packet length. For example, if the data packet is 1030 bytes long and the prenegotiated USB packet length is 512 bytes, the data packet will be divided into a first and second portions of 512 bytes each (for a total of 1024 bytes) and a third portion of only six bytes (for a grand total of 1030 bytes). Certain USB packet header information is added to each packet in a manner that those skilled in the pertinent art understand, and the USB packets are queued for sequential and serial transmission across a USB link 130 that spans the transmitting USB endpoint 120 and a receiving USB endpoint 140.

The first of the three USB packets traverses the USB link 130, where it is received and buffered in the receiving USB endpoint 140. In the illustrated embodiment, the first USB packet is simply buffered, and no further action is taken with respect to it. The second of the three USB packets then traverses the USB link 130, where it is also received and buffered in the receiving USB endpoint 140, preferably stored behind the first USB packet. Finally, the third of the three USB packets, which is a short USB packet, traverses the USB link 130 and is received and buffered in the receiving USB endpoint 140, preferably behind the second USB packet.

The present invention can make advantageous use of the short USB packet by interpreting it as more than simply a short USB packet, but instead as a more significant indication that the end of the data packet has been reached and thus that the entire data packet resides within the buffer. Only then is are the USB packets caused to issue from the USB endpoint.

Accordingly, when the short USB packet (symbolized by an arrow 150) is received, a short packet detector 160 responds by causing (symbolized by the arrow 170) at least some of the USB packets to issue from the receiving USB endpoint 140. In the illustrated embodiment, the short USB packet detector 160 responds by causing all three of the USB packets to issue from the receiving USB endpoint 140. A path 180 leads from the receiving USB endpoint 140 to a protocol stack (not shown in FIG. 1), which can receive and further process the USB packets.

In a second example, the data packet is 1024 bytes long. Exactly two USB packets can contain the data packet. It would seem that a short USB packet would not be forthcoming. However, as stated above, RNDIS specifies that if a packet's length is an even multiple of the maximum packet size, a byte of 0s is to be appended to the packet prior to transmission. The extra 0s byte ensures that the transfer always ends with a short USB packet. Accordingly, the data packet is divided into first, second and third portions (the third consisting solely of the 0s byte), and first, second and third USB packets are constructed around the first, second and third portions. The present invention also functions with respect to a USB protocol that calls for a data packet transfer to be terminated with an empty USB packet.

Accordingly, the receiving USB endpoint receives three USB packets. The first and second USB packets are full-length, but the third contains only the 0s byte. The short USB packet is detected upon receipt, and the first and second USB packets are caused to be issued from the receiving USB endpoint 140.

In alternative embodiments, the USB protocol that manages the USB link 130 is Communications Device Class (CDC). The present invention does not rely on a particular standard or proprietary USB protocol.

In the illustrated embodiment, the short packet detector 160 is configured to issue an interrupt to cause at least some (e.g., all) of the USB packets to issue from the receiving USB endpoint 140. Those skilled in the art will understand that other mechanisms exist within hardware or software to respond to receipt of a short packet and to command a resulting data packet issuance.

Also in the illustrated embodiment, the short packet detector 160 is configured to issue an interrupt only upon receipt of the short USB packet and not at other times; this limits the generation and concomitant handling of interrupts. Those skilled in the pertinent art will understand, however, that the short packet detector 160 can issue other interrupts without departing from the broad scope of the present invention.

In the illustrated embodiment, the short packet detector 160 is configured to respond to receipt of the short USB packet by causing at least some (e.g., all) of the USB packets to issue directly to a protocol stack (not shown) associated with said USB endpoint.

The buffer in the USB endpoint 160 is of limited size and may in fact be so small that long data packets may not fit completely into it. In such case, the buffer may be at least partially emptied when the buffer reaches a predetermined level of fullness. An end-of-buffer interrupt may be asserted to cause at least some of the USB packets to issue from the buffer before a short USB packet has been received. This at least partially empties the buffer and readies it to receive more USB packets.

Turning now to FIG. 2, illustrated is a flow diagram of one embodiment of a method of adaptively recognizing a data packet (such as an IP packet) constructed according to the principles of the present invention.

The method begins in a start step 210 when USB packets bearing a data packet are transmitted across a USB link. The USB packets are received by a USB endpoint in a step 220 and buffered in the USB endpoint in a step 230. Though not illustrated, the method may include a step of at least partially emptying the buffer when the buffer reaches a predetermined level.

Receipt of the short packet is responded to in a step 230. The response is at least to cause at least some of the USB packets to issue from the USB endpoint. The response may be to cause all of the USB packets to issue from the USB endpoint, and any conventional or later-discovered mechanism can be employed to cause some or all of the USB packets to be issued. The method ends in an end step 250.

While the method disclosed herein has been described and shown with reference to particular steps performed in a particular order, those skilled in the pertinent art will understand that these steps may be combined, subdivided, or reordered to form an equivalent method without departing from the teachings of the present invention. Accordingly, unless specifically indicated herein, the order or the grouping of the steps are not limitations of the present invention.

Turning now to FIG. 3, illustrated is a block diagram of one embodiment of a USB device containing a system-on-a-chip (SoC) 320 incorporating the circuit of FIG. 1 or the method of FIG. 2. FIG. 3 is presented primarily for the purpose of illustrating a larger device that falls within the scope of the present invention.

The USB link 130, receiving USB endpoint and short packet detector 160 correspond to those illustrated in FIG. 1. A USB connector 310 interposes the USB link 130 and the SoC 320. The USB connector 310 allows the cable embodying the USB link to be decoupled from the SoC 320.

A processor 330 governs the operation of the SoC 320 and is therefore coupled to its constituent components. For clarity and simplicity, however, FIG. 3 omits the various couplings.

The buffer, now designated 340, is shown separately from the receiving USB endpoint 140, although those skilled in the pertinent art understand that the USB endpoints conventionally include buffers.

Finally, a protocol stack 350 is illustrated. Those skilled in the pertinent art understand that a protocol stack is not a physical entity, but is instead an abstraction for managing the flow of data through a system. In reality, the processor 330 enables the protocol stack 350.

As described above, one or more USB packets are transmitted over the USB link 130 to the receiving USB endpoint 140. The one or more USB packets are buffered in the buffer 340 pending the receipt of a short USB packet. Upon the receipt of a short packet, the short packet detector 160 causes the USB packets to issue from the buffer 340. In the context of FIG. 3, all of the USB packets bearing a particular data packet issue directly to the protocol stack 350, where the data packet can be further processed.

It has been discovered empirically that application of the teachings of the present invention can offer significant increases in data transfer rate over a USB link. For example, the receive (Rx) rate can improve by over 50% given a data packet size of 64 bytes. The Rx rate can improve by over 120% given a data packet size of 1518 bytes. The transmit (Tx) rate can improve by almost 150% given a data packet size of 64 bytes. The Tx rate can improve by over 70% given a data packet size of 1518 bytes. These rate improvements, though significant, are merely exemplary.

Although the present invention has been described in detail, those skilled in the art should understand that they can make various changes, substitutions and alterations herein without departing from the spirit and scope of the invention in its broadest form.

1. A circuit for adaptively recognizing a data packet, comprising:
a USB endpoint configured to receive USB packets bearing portions of said data packet; and
a short packet detector associated with said USB endpoint and configured to respond to a received short USB packet by causing at least some of said USB packets to issue from said USB endpoint.

2. The circuit as recited in claim 1 wherein said USB packets conform to a USB protocol selected from the group consisting of:
Remote Network Driver Interface Specification (RNDIS), and
Communications Device Class (CDC).

3. The circuit as recited in claim 1 wherein said short packet detector is configured to issue an interrupt to cause said at least some of said USB packets to issue from said USB endpoint.

4. The circuit as recited in claim 1 wherein said short packet detector is configured to respond to said received short USB packet by causing all of said USB packets to issue from said USB endpoint.

5. The circuit as recited in claim 1 wherein said short packet detector is configured to respond to said received short USB packet by causing said at least some of said USB packets to issue to a protocol stack associated with said USB endpoint.

6. The circuit as recited in claim 1 wherein said short USB packet is an empty USB packet.

7. The circuit as recited in claim 1 wherein said data packet is a network layer protocol packet.

8. A method of adaptively recognizing a data packet, comprising:
receiving USB packets bearing portions of said data packet; and
responding to a received short USB packet by causing at least some of said USB packets to issue from an USB endpoint.

9. The method as recited in claim 8 wherein said USB packets conform to a USB protocol selected from the group consisting of:
Remote Network Driver Interface Specification (RNDIS), and
Communications Device Class (CDC).

10. The method as recited in claim 8 wherein said responding comprises issuing an interrupt to cause said at least some of said USB packets to issue from said USB endpoint.

11. The method as recited in claim 8 wherein said responding comprises causing all of said USB packets to issue from said USB endpoint.

12. The method as recited in claim 8 wherein said responding comprises causing said at least some of said USB packets to issue to a protocol stack associated with said USB endpoint.

13. The method as recited in claim 8 wherein said short USB packet is an empty USB packet.

14. The method as recited in claim 8 wherein said data packet is a network layer protocol packet.

15. The method as recited in claim 8 further comprising at least partially emptying a buffer associated with said USB endpoint when said buffer reaches a predetermined level.

16. A device, comprising:
a USB endpoint configured to receive USB packets bearing portions of said data packet; and
a short packet detector associated with said USB endpoint and configured to respond to a received short USB packet by causing at least some of said USB packets to issue from said USB endpoint to a protocol stack.

17. The device as recited in claim 16 wherein said USB packets conform to a USB protocol selected from the group consisting of:
Remote Network Driver Interface Specification (RNDIS), and
Communications Device Class (CDC).

18. The device as recited in claim 16 wherein said short packet detector is configured to issue an interrupt to cause said at least some of said USB packets to issue from said USB endpoint.

19. The device as recited in claim 16 wherein said short packet detector is configured to respond to said received short USB packet by causing all of said USB packets to issue from said USB endpoint.

20. The device as recited in claim 16 wherein said short packet detector is configured to respond to said received short USB packet by causing said at least some of said USB packets to issue to a protocol stack associated with said USB endpoint.

21. The device as recited in claim 16 wherein said short USB packet is an empty USB packet.

22. The device as recited in claim 16 wherein said data packet is a network layer protocol packet.

23. The device as recited in claim 16 further comprising:
a system-on-a-chip having:
a processor configured to enable said protocol stack, and
a buffer; and
a USB connector coupled to said USB endpoint.
